(19) United States
(12) Patent Application Publication
(10) Pub. No.: US 2018/0321121 A1
(43) Pub. Date: Nov. 8, 2018

(54) SENSOR ARRAY FOR REFRIGERANT DETECTION

(71) Applicant: Carrier Corporation, Palm Beach Gardens, FL (US)

(72) Inventors: Ivan Rydkin, Rochester, NY (US); Lei Chen, South Windsor, CT (US); Warren Clough, Cicero, NY (US); Parmesh Verma, South Windsor, CT (US); Paul Papas, West Hartford, CT (US); Larry D. Burns, Avon, IN (US); Meredith B. Colket, Avon, CT (US)

(21) Appl. No.: 16/070,970

(22) PCT Filed: Jan. 18, 2017
(86) PCT No.: PCT/US2017/013977

§ 371 Date: Jul. 18, 2018

Related U.S. Application Data
(60) Provisional application No. 62/280,485, filed on Jan. 19, 2016.

(51) Int. Cl. G01N 7/10; G01M 3/04; F25B 49/00; F24F 11/36

(52) U.S. Cl. CPC G01N 7/10; F24F 11/36; F25B 49/005; G01M 3/042

(57) ABSTRACT

An HVAC/R assembly including an HVAC/R unit including a casing, a heat exchanger disposed within the casing, the heat exchanger configured to circulate a refrigerant therethrough, and a plurality of sensing devices in communication with the HVAC/R unit, wherein each of the plurality of sensing devices is configured to detect a presence of the refrigerant.

### CROSS-REFERENCE TO RELATED APPLICATION

The present application is an international application, which claims priority to U.S. Patent Application Ser. No. 62/280,485, filed Jan. 19, 2016, which is herein incorporated in its entirety.

### TECHNICAL FIELD OF THE DISCLOSED EMBODIMENTS

The presently disclosed embodiments generally relate to heating, ventilation, and air conditioning and refrigeration (“HVAC/R”) systems, and more particularly, to a sensor array for refrigerant detection.

### BACKGROUND OF THE DISCLOSED EMBODIMENTS

Refrigeration systems, as used in HVAC/R applications, utilize a closed loop refrigerant circuit to condition air inside an interior space. Over the years, the HVAC/R industry has been using refrigerants with ozone depleting chlorofluorocarbons (CFCs) and hydrochlorofluorocarbons (HCFCs); however, the use of ozone depleting refrigerants is currently being phased out of the industry.

New refrigerants have been developed to comply with environmental regulations relating to global warming potential (GWP). In order to comply with the proposed GWP regulations, hydrofluorocarbon (HFC) and hydrocarbon refrigerants with various levels of flammability are being developed and are being considered for use in HVAC/R systems.

As with any system, there is a potential for flammable refrigerants used in HVAC/R applications to leak and migrate to undesirable areas in the vicinity of the HVAC/R system. When the flammable refrigerants, in the presence of air or another oxidizer, are exposed to an ignition source, the potential for a combustion event exists if the mixture is above the lower flammability limit (LFL) and below the upper flammability limit (UFL). There is therefore a need for an HVAC/R system which detects a refrigerant leak and mitigates the possibility of igniting a leaked refrigerant.

### SUMMARY OF THE DISCLOSED EMBODIMENTS

In one aspect, an HVAC/R assembly is provided. The HVAC/R assembly includes an HVAC/R unit and a plurality of sensing devices in communication with the HVAC/R unit. The HVAC/R unit includes a casing and a heat exchanger disposed within the casing, the heat exchanger configured to circulate a refrigerant therethrough. Each of the plurality of sensing devices is configured to detect a presence of the refrigerant.

In an embodiment, the HVAC/R unit is disposed within a volume. In any of the preceding embodiments, at least one of the plurality of sensing devices is disposed within the HVAC/R unit and at least one other of the plurality of sensing devices is disposed within the volume and external of the HVAC/R unit.

In any of the preceding embodiment, the HVAC/R assembly further includes at least one conduit operably coupled to the HVAC/R unit. In this embodiment, at least one of the plurality of sensing devices is disposed within the HVAC/R unit and at least one other of the plurality of sensing devices is disposed within the conduit.

In any of the preceding embodiments, one or more of the plurality of sensing devices is configured to detect a concentration level of the refrigerant. In this embodiment, the concentration level of the refrigerant comprises at least one of an occupational exposure limit and a refrigerant concentration limit. In one embodiment, one or more of the plurality of sensing devices is configured to change states at the presence of the refrigerant.

In any of the preceding embodiments, the HVAC/R unit 12 further includes a fan assembly in airflow communication with the heat exchanger. In any of the preceding embodiments, the HVAC/R unit further includes a controller operably coupled to the fan assembly and the plurality of sensing devices. In an embodiment, the controller is configured to perform diagnostics based in part on an output from the plurality of sensing devices. In an embodiment, the controller is further configured to perform a mitigation action based in part on the presence of the refrigerant. In one embodiment, the mitigation action includes at least one of stopping the flow of refrigerant within the heat exchanger, adjusting an airflow rate of the fan assembly, initiate an alarm, and stopping the HVAC/R unit.

In an embodiment, the HVAC/R unit further includes an ignition source. In this embodiment, the mitigation action comprises disabling the ignition source.

In an embodiment, the HVAC/R assembly further includes at least one damper operably coupled to the at least one conduit and in operable communication with the controller; wherein the at least one damper is configured to operate between an open state and a closed state. In this embodiment, the mitigation action comprises placing the at least one damper in a closed state.

In any embodiment of the HVAC/R assembly, the refrigerant includes a flammable refrigerant. In another embodiment, the refrigerant includes a toxic refrigerant

### BRIEF DESCRIPTION OF DRAWINGS

FIG. 1 illustrates a schematic diagram of an HVAC/R system according to an embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

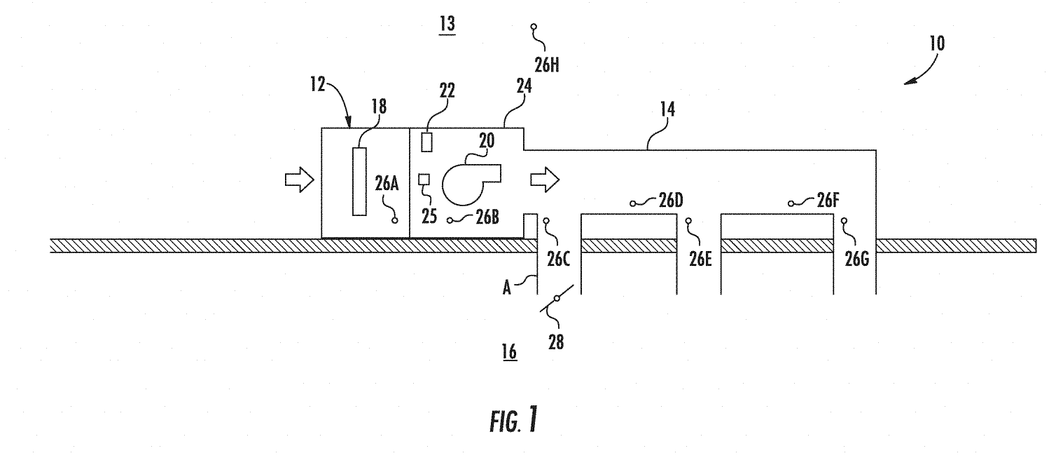

FIG. 1 schematically illustrates an embodiment of an HVAC/R assembly, generally indicated at 10. In the embodiment shown, the HVAC/R assembly 10 includes an HVAC/R unit 12 disposed within a volume 13. In another embodiment, as shown in FIG. 1, the HVAC/R unit 12 is operably coupled to a conduit 14. The HVAC/R unit 12, for example an air handler within a mechanical closet, to name one non-limiting example, is configured to deliver conditioned air through the conduit 14 to an interior space 16. In another example, the HVAC/R unit 12 may be a chiller disposed within a machine room.

The HVAC/R unit 12 includes a heat exchanger 18 disposed within a casing 24. In an embodiment, the HVAC/R unit 12 includes a fan assembly 20 in airflow communication with the heat exchanger 18. It will be appreciated that the fan assembly 20 may or may not be disposed within the casing 24. In an embodiment, the HVAC/R unit further comprises an ignition source 25 disposed within the casing 24.

In an embodiment, the HVAC/R unit 12 includes a controller 22. It will be appreciated that the controller 22 may be internal or external of the casing 24. The controller 22 is operably coupled to the fan assembly 20 to control the operation thereof. The heat exchanger 18 is configured to circulate a refrigerant therethrough. In one embodiment the refrigerant includes a flammable refrigerant. For example, such refrigerants as R-32, R-290, R-1234yf, and R-1234ze(E) to name a few non-limiting examples. In another embodiment, the refrigerant includes a toxic refrigerant. It will be appreciated that the toxic refrigerant may not necessarily be flammable.

For example, to condition the air within the interior space 16, refrigerant may be circulated through the heat exchanger 18 from a second HVAC/R unit (not shown). The controller 22 operates the fan assembly 20 to rotate; thus, pulling conditioned air from the HVAC/R unit 12 into the conduit 14 where it may be distributed to the interior space 16. It will be appreciated that in some embodiments, the HVAC/R unit 12 and the second HVAC/R unit may be within the same casing 24.

The HVAC/R assembly 10 further includes a plurality of sensing devices 26A-H operably coupled to the controller 22. In one embodiment, at least one of the plurality of sensing devices 26A-B is disposed within the HVAC/R unit 12 and at least one other of the plurality of sensing devices 26C-G is disposed within the at least one conduit 14. In another embodiment, at least one of the plurality of sensing devices 26A-B is disposed within the HVAC/R unit 12 and at least one other of the plurality of sensing devices 26H is disposed within the volume 13.

In an embodiment, the plurality of sensing devices 26A-H are configured to continuously monitor and/or measure the magnitude of the presence of a refrigerant. In an embodiment, the plurality of sensing devices 26A-H are further configured to monitor and/or measure the magnitude of the presence of the refrigerant either as pure components, part of a blend, or other gasses; at or below a target occupational exposure limit (OEL), and/or a refrigerant concentration limit (RCL). It will be appreciated that the OEL and RCL for a give refrigerant may be found in the Safety Standard for Refrigeration Systems (e.g., ASHRAE STD 34) In the embodiment shown, there are eight sensing devices; however, it will be appreciated that there may be more than eight sensing devices or fewer than eight sensing devices.

In an embodiment, one or more of the plurality of sensing devices 26A-H is an analog device that provides a none-discrete input to the controller 22 (e.g., a 4-20 mA input, a 0-5 VDC input, or the like) such that the controller 22 can convert the signal input to a magnitude of the refrigerant concentration that the sensing device 26A-H is sensing. In another embodiment, one or more of the plurality of sensing devices 26A-H is a digital device which changes between discrete states when the sensed refrigerant concentration exceeds one or more threshold value(s). Furthermore, it will be appreciated that a digital refrigerant sensing device can have multiple thresholds set therein such that when the sensed concentration exceeds a first threshold the sensor indicates a first value (e.g., low refrigerant concentration) and when the sensed concentration exceeds a second threshold the sensor indicates a second value (e.g., medium refrigerant concentration, high refrigerant concentration, and the like). It will be appreciated that any number of thresholds (pre-set or dynamically set in real-time) are contemplated.

It will be appreciated that the plurality of sensing devices 26A-H may include a discrete and/or analog output, or communicate to the controller 22 over a system bus. It will further be appreciated that the plurality of sensing devices 26A-H provides redundancy in the HVAC/R assembly 10 should one of the plurality of sensing devices 26A-H fail.

In an embodiment, the controller 22 is further configured to assign a threshold value (for example the OEL and/or the RCL) for each of the plurality of sensing devices 26A-H, and determine the directional flow of the refrigerant based on the output of the plurality of sensing devices 26A-H. In one embodiment, the controller 22 may perform different mitigation actions, such as, reducing air flow, stopping the flow of refrigerant, increasing air flow, deactivating any electrical connections, etc. to name a few non-limiting examples, based in part on the presence of refrigerant detected at any one or more of the plurality of sensing devices 26A-H.

For example, if the sensing device 26A detects refrigerant above a first sensor threshold, the controller 22 may take the action to stop the flow of refrigerant within the heat exchanger 18. Furthermore, if sensing device 26B detects the refrigerant above a second sensing threshold, the controller 22 may take the action to operate the fan assembly 20 at a first detection speed. Operating the fan assembly 20 at a first detection speed my lower the flammability concentration; thus, reducing the likelihood the refrigerant would ignite when exposed to a potential ignition source.

If the sensing device 26C detects the refrigerant above a third sensing threshold, the controller 22 may determine that the refrigerant gas is present within the conduit 14 and take additional actions to mitigate the spread of the refrigerant. For instance, the controller 22 may increase the operational speed of the fan assembly 20 to a second detection speed, and may close a damper 28 to prevent the refrigerant from entering the interior space 16 from the conduit 14, designated as conduit A. It will be appreciated that the controller 22 may take different mitigation actions based on the detection and/or concentration level of the refrigerant detected by any of the sensing devices 26A-H.

In some embodiments, outputs of the sensing devices 26A-H, in conjunction with the operation of the fan assembly 20, allows the controller 22 to perform a level of diagnostics to determine if false alarms are possible. For example, when the furthest sensing device 26G registers a higher response than the sensing device closest to the source of refrigerant (e.g., sensing device 26A) in the HVAC/R unit 12, the controller 22 may determine this is likely a false alarm. Thereby, mitigation action may be delayed until further input from other sensing devices can confirm the presence of refrigerant. It will be appreciated that the controller 22 may continuously or intermittently monitor a baseline output of the sensing devices 26A-H to ensure failure of the sensing devices 26A-H is detectable and notifications may be transmitted to inform users if such failures occur.

It will therefore be appreciated that the present HVAC/R assembly 10 includes a controller 22 operably coupled to a plurality of sensing devices 26A-H disposed within the HVAC/R unit 12 and/or the conduit 14 and/or the volume 13 to detect a presence of refrigerant and to perform different mitigation actions to prevent the ignition of the refrigerant.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

1. An HVAC/R assembly comprising:
an HVAC/R unit comprising:
a casing; and
a heat exchanger disposed within the casing, the heat exchanger configured to circulate a re rigerant therethrough; and
a plurality of sensing devices in communication with the HVAC/R unit;
wherein each of the plurality of sensing devices is configured to detect a presence of the refrigerant.

2. The HVAC/R assembly of claim 1, wherein the HVAC/R unit is disposed within a volume.

3. The HVAC/R assembly of claim 1, wherein at least one of the plurality of sensing devices is disposed within the HVAC/R unit and at least one other of the plurality of sensing devices is disposed within the volume and external of the HVAC/R unit.

4. The HVAC/R assembly of claim 1, further comprising at least one conduit operably coupled to the HVAC/R unit.

5. The HVAC/R assembly of claim 4, wherein at least one of the plurality of sensing devices is disposed within the HVAC/R unit and at least one other of the plurality of sensing devices is disposed within the conduit.

6. The HVAC/R assembly of claim 1, wherein one or more of the plurality of sensing devices is configured to detect a concentration level of the refrigerant.

7. The HVAC/R assembly of claim 6, wherein the concentration level of the refrigerant comprises at least one of an occupational exposure limit and a refrigerant concentration limit.

8. The HVAC/R assembly of claim 1, wherein one or more of the plurality of sensing devices is configured to change states at the presence of the refrigerant.

9. The HVAC/R. assembly of claim 1, wherein the HVAC/R unit further comprises a fan assembly, the fan assembly in airflow communication with the heat exchanger.

10. The HVAC/R assembly of claim 1, further comprising a controller operably coupled to the fan assembly and the plurality of sensing devices.

11. The HVAC/R assembly of claim 10, wherein the controller is configured to perform diagnostics based in part on an output from the plurality of sensing devices.

12. The HVAC/R assembly of claim 10, wherein the controller is configured to perform a mitigation action based in part on the presence of the refrigerant.

13. The HVAC/R assembly of claim 12, wherein the mitigation action comprises at least one of stopping the flow of refrigerant within the heat exchanger, adjusting an airflow rate of the fan assembly, initiate an alarm, and stopping the HVAC/R unit.

14. The HVAC/R assembly of claim 13, wherein the HVAC/R unit further comprises an ignition source.

15. The HVAC/R assembly of claim 14, wherein the mitigation action comprises disabling the ignition source.

16. The HVAC/R assembly of claim 4, further comprising at least one damper operably coupled to the at least one conduit and in operable communication with the controller; wherein the at least one damper is configured to operate between an open state and a closed state.

17. The HVAC/R assembly of claim 16, wherein the mitigation action comprises placing the at least one damper in a closed state.

18. The HVAC/R assembly of claim 1, wherein the refrigerant comprises a flammable refrigerant.

19. The HVAC/R assembly of claim 1, wherein the refrigerant comprises a toxic refrigerant.
